(19) United States
(12) Patent Application Publication
(10) Pub. No.: US 2015/0380832 A1
(43) Pub. Date: Dec. 31, 2015

(54) IMPROVEMENTS IN AND RELATING TO RADAR

(71) Applicant: BAE SYSTEMS PLC, London (GB)

(72) Inventors: MICHAEL ANDREW SCOTT, Isle of Wight, Hampshire (GB); MALCOLM JOHN QUINNEY, Chelmsford, Essex (GB)

(73) Assignee: BAE SYSTEMS plc, London (GB)

(21) Appl. No.: 14/769,706

(22) PCT Filed: Feb. 24, 2014
(86) PCT No.: PCT/GB2014/050547

§ 371 Date: Aug. 21, 2015

(30) Foreign Application Priority Data
Feb. 22, 2013 (EP) 13275039.9
Feb. 22, 2013 (GB) 1303143.0

(51) Int. Cl. H01Q 21/29; H01Q 21/08; H01Q 21/22; H01Q 21/00

(52) U.S. Cl. CPC H01Q 21/293; H01Q 21/0087; H01Q 21/08; H01Q 21/22

(57) ABSTRACT

An antenna comprising two or more substantially identical antenna sub-arrays (3A, 3B) each comprising a plurality of separate antenna radiating elements (6A, 6B) connected to a common radio frequency (RF) signal input/output port (4A, 4B). The separate antenna elements are connected to the RF signal input/output port via respective RF signal power dividers (8A, 8B). A variance in values of the power splitting ratio, and/or of the input RF signal reflectivity, and/or of the phase balance of corresponding signal power dividers of the two or more antenna sub-arrays is sufficient to provide a cancellation ratio exceeding 40 dB. Alternatively, the separate antenna elements are connected to the RF signal input/output port via respective transmission paths (7A, 7B) and a variance in values of the transmission path lengths of corresponding signal transmission paths of the two or more antenna sub-arrays is sufficient to provide a cancellation ratio exceeding 40 dB.

### FIELD OF THE INVENTION

The present invention relates to antennas for adaptive beam-forming systems, such as, though without limitation to, adaptive beam-forming radar systems.

### BACKGROUND

So-called “pattern diversity” in antenna beam patterns is highly desirable in adaptive beam-forming systems, or systems for performing so-called “adaptive nulling” or “adaptive null steering” which is a particular type of adaptive beam-forming. This is because adaptive beam forming adaptively generates an antenna beam by a weighted sum of the beam patterns of each of the sub-antennas/arrays forming the overall antenna. When the sub-antennas/arrays of the antenna apparatus are directional (i.e. not omni-directional), they tend to form beam patterns which have high gain in a narrow angular range (the “main beam” or “main lobe” of the beam pattern) and a lower gain at a series of other narrow angular ranges (“side lobes”) either side of the main beam and separated by “nulls” in gain where the sensitivity of the beam falls dramatically. It is desirable that in an adaptive beam forming apparatus, a null in the beam pattern of any one sub-antenna/array of the overall array, coincides with the angular position of at least a part of a side lobe in the beam pattern of another one or more sub-antenna/array of the overall array. Consequently, the overall antenna is able to construct a beam pattern, if necessary, that selectively does or does not have a null in that direction. Differences in the sidelobe levels of different sub-arrays permit this and allow adaptive nulling, for example.

This can be achieved using two or more co-located antennas/arrays each displaying different beam patterns. Directive radar antennas are usually used comprising a number of sub-antennas, or antenna sub-arrays, which are physically separated by some short distance. The central lobe defining the main antenna beam formed by each such separate sub-antenna/array is arranged to be similar in position and shape to that of the other sub-antenna/array. However, for the purposes of adaptive beam forming, it is highly preferable that their respective side lobes are not very similar in position. The side-lobe patterns of the sub-antennas/arrays should preferably be sufficiently different, or “diverse” in that they are positioned at different directions (e.g. elevation, azimuth) and/or to allow beam pattern nulls to be selectively formed in desired directions, e.g. for adaptive nulling,. However, to provide such pattern diversity traditionally requires a diversity in a physical location, size or shape of sub-antennas/arrays, or in their directions and/or slightly different levels. This may result in a larger antenna than would be the case were pattern diversity not required, or one more complex to design and to produce. This is problematic where antenna size is to be as small as possible, and/or complexity is to be minimised.

The present invention addresses this.

### SUMMARY OF THE INVENTION

Whereas one would expected an antenna design comprising identical and regularly-spaced sub-antennas/arrays to be lacking in pattern diversity due to the uniformity of the sub-antennas/arrays, the inventors have been surprised to find that this is not so, under certain circumstances. In fact, random variations in structural features on the sub-antennas/arrays (e.g. in the structure of RF transmission lines, if used) produce an adequate degree of pattern diversity. The side lobe levels of different sub-antennas/arrays has been found typically to vary with sufficient diversity so that the overall array may collectively support adaptive beam-forming, e.g. adaptive nulling, and be capable of providing controllably variable (e.g. nullable) antenna gain over a large portion of angular space.

By achieving a suitable bounded range of variation in corresponding antenna structural and/or performance parameters, as between substantially identical sub-antennas/arrays in an antenna, the side-lobe patterns of different sub-antennas/arrays may become sufficiently diverse as a direct result, without introducing so much variation as to degrade performance overall.

This pattern diversity may be achieved by suitable bounded variations in the effects of:
(1) The imperfect splitting of RF power by power dividers when diverting RF power to/from individual terminal antenna radiating elements within a sub-array—RF amplitude variations result;
(2) RF signal reflection at power dividers—the reflected wave interferes with other RF waves causing RF amplitude and phase variations;
(3) Differences in path lengths along the transmission lines (e.g. waveguides) serving the radiating antenna elements of a sub-array;

In a first aspect, the invention may provide an antenna comprising two or more substantially identical antenna sub-arrays each comprising a plurality of separate antenna radiating elements connected to a common radio frequency (RF) signal input/output port, wherein the separate antenna elements are connected to the RF signal input/output port via respective RF signal power dividers and a variance in values of the power splitting ratio, and/or of the input RF signal reflectivity, and/or of the phase balance of corresponding signal power dividers of the two or more antenna sub-arrays is sufficient to provide a cancellation ratio exceeding 40 dB, or more preferably 45 dB or yet more preferably 50 dB or even more preferably 55 dB. For example, the variance(s) may be greater than a suitable finite value sufficient to provide a cancellation ratio as desired. Actual suitable variance values of these individual design parameters may vary greatly as between one antenna array design/structure and another, different array design/structure, whilst achieving the same cancellation ratio result. This means that it is not possible to place specific values on the lower limits of the variances described above, which will be fully general and applicable to all and any antenna design/structure. However, it is desirable that, whatever the specific antenna design/structure at hand, it is preferable to determine and impose a finite lower threshold to the variance of one or more of the relevant design parameters described herein, to ensure that there is sufficient variance to provide the desired cancellation ratio.

The cancellation ratio may be measured between two equivalent radiating elements in two separate respective sub-arrays. A two-channel cancellation ratio (CR) (see below) may be defined in terms of input and output signals to two channels, as would be readily understood by the skilled person. However, other known definitions such as may be readily applied by the skilled person, may be employed.

This provides a means of generating a desired level of beam pattern diversity even in respect of an antenna array comprising substantially identical antenna sub-arrays. The antenna sub-arrays may be substantially identical in terms of their dimensions, and/or components, and/or structure, and/or manufacture, and/or materials etc.

Alternatively or additionally, the separate antenna elements are connected to the RF signal input/output port via respective transmission paths (e.g. transmission lines, or the like) and a variance in values of the transmission path lengths of corresponding signal transmission paths of the two or more antenna sub-arrays is sufficient to provide a cancellation ratio exceeding 40 dB, or more preferably 45 dB or yet more preferably 50 dB or even more preferably 55 dB. For example, the variance(s) may be greater than a suitable finite value sufficient to provide a cancellation ratio as desired.

A two-channel cancellation ratio (CR) is a measure of the level of inter-channel matching. It may be defined as:

$$CR = \frac{〈 {x}^{2} ( t ) 〉}{〈 {e}^{2} ( t ) 〉}$$

where [symbol] e²(t) [symbol] is the mean squared value of e(t), the difference between the outputs of two channels in question, and [symbol] x²(t) [symbol] is the mean squared value of x(t), the input to each channel.

In general, the error between the outputs of the two channels is caused by either independent internal noise in each of the channels or by differences within the channels themselves (e.g. hardware differences). Furthermore, if one assumes that each channel has an independent thermal noise with power σₙ² at the input, then it can be shown that the cancellation ratio is non-zero and proportional to σₙ². Thus, even for the case where there is no hardware difference between channels, there is a lower limit to the cancellation ratio, CR. The traditional goal of hardware design in antenna systems is to make as small as possible the contribution to the overall cancellation ratio arising from the sum of all hardware contribution, and to make it less than the upper bound imposed by thermal noise. For an n-element antenna array, it can be shown that the relationship between the cancellation ratio (CR) the null depth (ND) of nulls in the beam pattern of the antenna is given by:

$$ND = \frac{CR}{2 n}$$

Thus, it is possible to use the two-channel cancellation ratio definition given above to estimate the nulling capability of a full n-element antenna array.

The present invention recognises that suitable variances in antenna pattern side lobe levels may be exploited for adaptive beam-forming, if sufficient pattern diversity is achieved even in an antenna array comprising substantially identical antenna sub-arrays. A new way of ensuring (or, controlling) pattern diversity is by setting a lower limit on the variances/errors of key features of the substantially identical antenna arrays, in addition to the upper limit traditionally set by the design specifications for a given desired side lobe level (or by manufacturing quality standards). The key features identified above, alone or in any combination, provide a means by which the variances between the performance of corresponding antenna radiating elements may be achieved/controlled. The cancellation ratio, such as the two-channel cancellation ratio (CR) as defined above, is a means of measurably quantifying the effects of these variances. In practice, cancellation ratios may be measured using trials equipment such as would be known and available to the skilled person. For example, an interference radio source of known characteristics may be placed at a defined distance from the antenna array. The signals received by the antenna array, from the known source, may then be analysed with adaptive beam forming of the antenna array turned off (in the first instance) and then turned on so as to arrive at a figure for the cancellation ratio.

The separate antenna elements are preferably connected to the RF signal input/output port via respective stripline transmission lines. The stripline transmission lines may comprise suspended stripline transmission lines. The stripline transmission lines may comprise a channelized air stripline waveguides.

The separate antenna elements are preferably connected to the RF signal input/output port via respective RF signal power dividers formed from stripline waveguides. A mean value of the signal power splitting ratio of the corresponding RF signal power dividers may be 3 dB, of may be greater than 3 dB—e.g. in the range between 3 dB and about 9 dB.

Each sub-array is preferably substantially planar. The plurality of separate antenna radiating elements are preferably connected to the radio frequency (RF) signal input/output port substantially in a common plane. The two or more sub-arrays preferably are arranged substantially in parallel.

At least two of the two or more sub-arrays are arranged mutually in register. The respective radiating elements of a first sub-array are preferably substantially in register with the radiating elements of a second sub-array.

In a second aspect, the invention may provide a method of manufacturing an antenna comprising two or more substantially identical antenna sub-arrays each having a plurality of separate antenna radiating elements connected to a common radio frequency (RF) signal input/output port, the method including providing the separate antenna elements connected to the RF signal input/output port via respective RF signal power dividers formed such that a variance in values of the power splitting ratio, and/or of the input RF signal reflectivity, and/or of the phase balance of corresponding signal power dividers of the two or more antenna sub-arrays is sufficient to provide a cancellation ratio exceeding 40 dB, or more preferably 45 dB or yet more preferably 50 dB or even more preferably 55 dB. For example, the variance(s) may be greater than a suitable finite value sufficient to provide a cancellation ratio as desired.

Alternatively or additionally, the method may include providing the separate antenna elements connected to the RF signal input/output port via respective transmission paths (e.g. transmission lines, or the like) formed such that a variance in values of the transmission path lengths of corresponding signal transmission paths of the two or more antenna sub-arrays is sufficient to provide a cancellation ratio exceeding 40 dB, or more preferably 45 dB or yet more preferably 50 dB or even more preferably 55 dB. For example, the variance(s) may be greater than a suitable finite value sufficient to provide a cancellation ratio as desired.

The method may include providing the sub-arrays with the separate antenna elements connected to the RF signal input/output port via respective stripline transmission lines. The method may include providing the stripline transmission lines in the form of suspended stripline transmission lines. The method may include providing the stripline transmission lines in the form of channelized air stripline transmission lines.

The sub-arrays may be provided with the separate antenna elements connected to the RF signal input/output port via respective RF signal power dividers formed from stripline waveguides.

The corresponding signal power dividers may be provided with a mean value of the signal power splitting ratio which is greater than 3 dB, of which is greater than 3 dB—e.g. in the range between 3 dB and about 9 dB.

Each sub-array may be provided as substantially planar. The plurality of separate antenna radiating elements are preferably connected to the radio frequency (RF) signal input/output port substantially in a common plane. The method preferably includes arranging the two or more sub-arrays substantially in parallel. The method may include arranging at least two of the two or more sub-arrays mutually in register with the respective radiating elements of a first sub-array substantially in register with the radiating elements of a second sub-array.

### BRIEF DESCRIPTION OF THE DRAWINGS

A non-limiting but illustrative example of one embodiment of the invention shall now be described with reference to the accompanying drawings of which:

FIG. 1 is a diagram showing the beam patterns of two identical antenna sub-arrays of a radar antenna;

FIG. 2 schematically shows an antenna according to an embodiment of the invention for use in radar applications;

FIG. 3 schematically shows a perspective view of the antenna of FIG. 2;

FIG. 4 shows the beam patterns of the two sub-arrays of the antenna of FIG. 2 and FIG. 3;

FIG. 5 graphically shows the distribution and variance in the measured values of corresponding properties of the sub-arrays of the antenna of FIG. 2 and FIG. 3;

FIG. 6 schematically shows a cross-sectional view of a stripline signal waveguide of any of the antenna sub-arrays of the antenna of FIG. 2 and FIG. 3;

FIG. 7 schematically shows a signal power divider of any of the antenna sub-arrays of the antenna of FIG. 2 and FIG. 3, formed in the stripline of FIG. 6.

### DETAILED DESCRIPTION

In the drawings, like items are assigned like reference symbols.

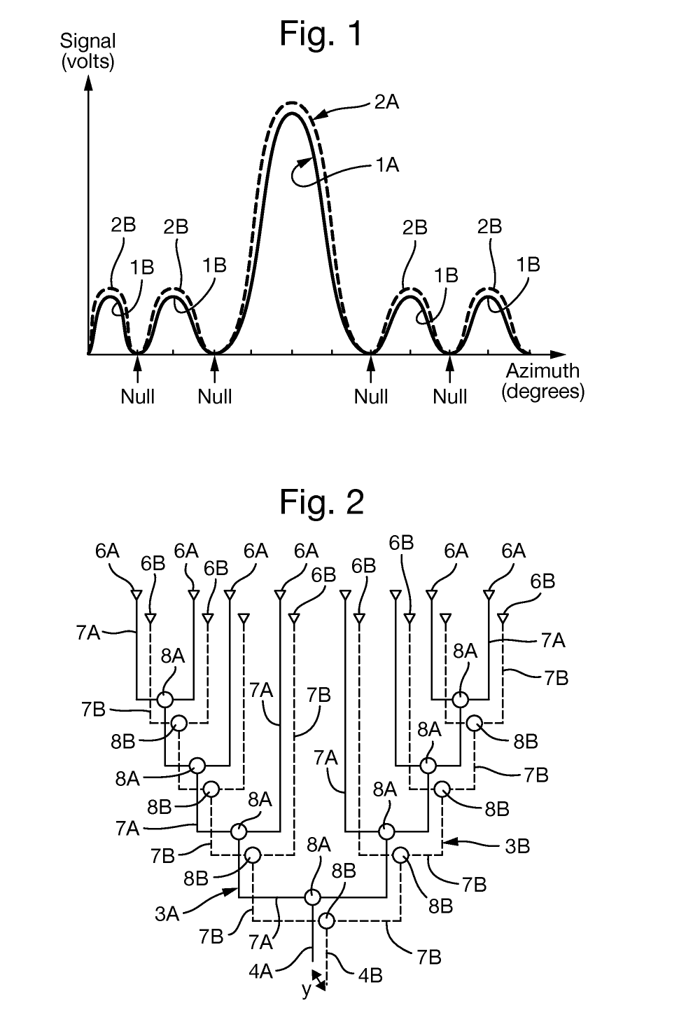

FIG. 1 shows the angular distribution, in azimuth, of the radar beam sensitivity pattern of an antenna comprising two identical sub-arrays of antennas. The antenna comprises a first antenna sub-array consisting of a plurality of separate radiating antenna elements connected to a common input/output signal port. A first beam pattern (1) corresponding to the first sub-array displays a main beam (1A) and a number of side-lobes (1B) each spaced from the main beam and/or from a neighbouring side lobe (1B) by a beam “null” point where the beam pattern falls close to zero (effectively so for practical purposes).

The antenna comprises a second antenna sub-array which consists of a plurality of separate radiating antenna elements connected to a common input/output signal port. A second beam pattern (2) corresponds to the second sub-array and comprises a main beam (2A) and a number of side-lobes (2B) each spaced from the main beam and/or from a neighbouring side lobe (2B) by a beam “null” point where the beam patter falls to, or close to, zero. To the extent that the second antenna sub-array is identical to the first antenna sub-array, so too is the second beam pattern identical to the first beam pattern. In FIG. 1, the second beam pattern (2) is shown slightly raised above the first beam pattern. This is for illustrative purposes only. One would expect the two beam patterns to overlie each other exactly, or nearly so, across the azimuthal range of the beam patterns.

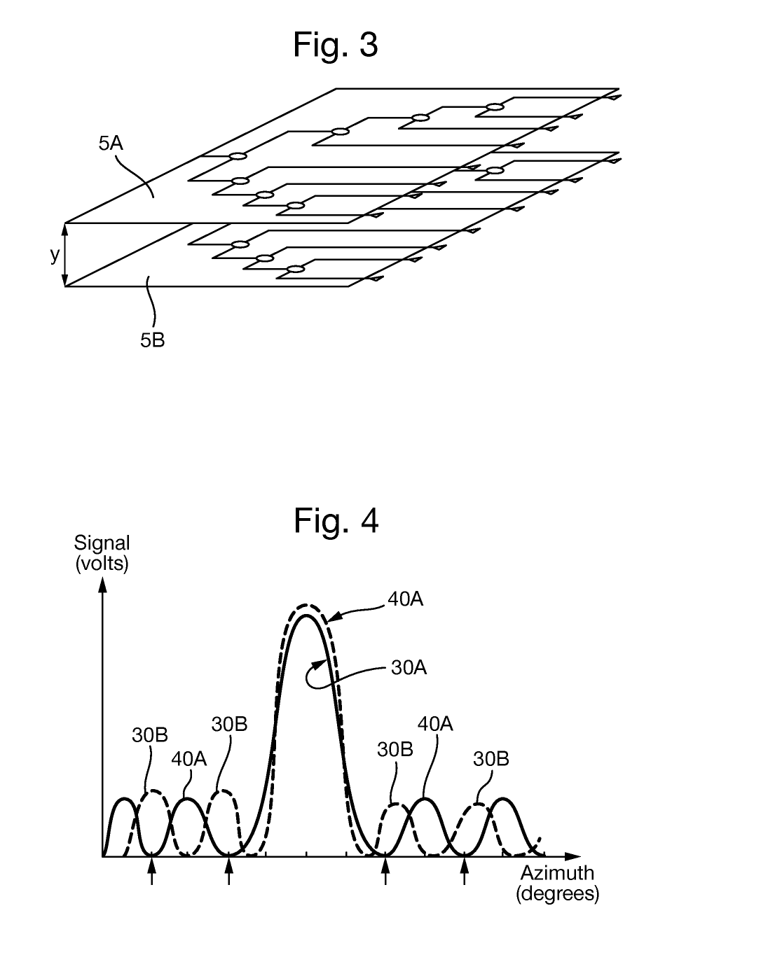

FIGS. 2 and 3 schematically illustrate an antenna according to an embodiment of the invention and comprising two substantially identical antenna sub-arrays (3A, 3B) each having eight separate antenna radiating elements connected to a common radio frequency (RF) signal input/output port (4A, 4B). Each of the two sub-arrays is substantially planar with the first sub-array lying within a first, upper plane (5A) and the second sub-array lying within a lower, parallel plane (5B) separated from the first array by a uniform vertical distance (y) across the whole of each of the two planes. The eight antenna radiating elements (6A) of the first antenna sub-array are connected to the radio frequency (RF) signal input/output port (4A) of the first sub-array via stripline waveguides all substantially in a common plane. Similarly, the corresponding eight antenna radiating elements (6B) of the second antenna sub-array are connected to the radio frequency (RF) signal input/output port (4B) of the second sub-array via stripline transmission lines which are also all substantially in a common plane.

The two antenna sub-arrays are arranged mutually in register such that the respective radiating elements (6A) of a first sub-array are substantially in register with the radiating elements (6B) of a second sub-array. This means that each radiating element (6A) of he first antenna sub-array (3A) is connected to the signal input/output port (4A) of that sub-array via a length of stripline waveguide (7A) which is in register with, and has substantially the same length, dimensions and structure as, the corresponding length of stripline waveguide (7B) via which a corresponding radiating element (6B) of the second antenna sub-array (3B) is connected to the input/output port (4B) of that second sub-array.

The first antenna sub-array comprises seven separate RF signal power dividers (8A) arranged in cascade to split an RF transmission signal originating from the signal input/output port (4A) in to eight separate RF signals for transmission from the eight radiating antenna elements (6A) of the first antenna sub-array. By reciprocal operation, the power dividers are also arranged to combine an incoming RF signal received at the eight radiating elements for input to the input/output port.

The second antenna sub-array (3B) also comprises seven separate RF signal power dividers (8B) arranged in cascade to split an RF transmission signal originating from the signal input/output port (4B) in to eight separate RF signals for transmission from the eight radiating antenna elements (6B) of the second antenna sub-array. By reciprocal operation, the power dividers are also arranged to combine an incoming RF signal received at the eight radiating elements for input to the input/output port.

Each signal power divider of each antenna sub-array has substantially a 3 dB power splitting ratio (i.e. equal split), and is formed within the stripline waveguide structure which connects the radiating elements to the signal input/output port of the antenna sub-array.

This is schematically illustrated in FIG. 7 which shows a bifurcation (70) in an input port (71) of the power divider formed in the stripline waveguide. This bifurcation is structured to provide two substantially equal amounts of RF power on each one of two output striplines (75, 77) of the power divider. Thus, each power divider substantially diverts an equal share (73, 74) of the RF power input to it (72) via the two output ports of the power divider (76, 78).

In each antenna sub-array, the power divider closest to the signal input/output port (4A, 4B) of the array, is arranged to divert power to a subsequent three power dividers in a cascade extending from one of the two output ports of that closest power divider.

Each one of the three such subsequent power dividers arranged to direct a share of the split power directly to a radiating antenna element (6A, 6B) via one output port of the power divider, and the first two of the subsequent three power dividers is arranged to direct the other share of the split power to the input port of a subsequent power divider, for subsequent power division. The third and final power divider of the three subsequent power dividers, being furthest from the signal input/output port (4A, 4B) directs each share of the RF power it receives, and splits, to two of the eight radiating antenna elements directly. Both the first and second antenna sub-arrays are arranged in this way. The power dividers of the first sub-array are arranged over, and in register with, the corresponding power dividers of the second antenna sub-array.

In this way, a stacked antenna array is provided comprising a vertical stack of two substantially identical and horizontally-arrayed, generally flat antenna sub-arrays of radiating elements. The stacked, flat structure of the antenna reduces its volume significantly, and the substantially identical structure of the two sub-arrays makes modular construction easy—the antenna can be enlarged simply by adding more such sub-arrays to the stack. This also means that parts, components and machinery are required only for manufacturing one modular sub-array unit. This reduces manufacturing cost and complexity.

However, with such an antenna of substantially identical horizontal sub-arrays, one would expect the azimuthal beam pattern of each sub-array to be substantially identical to that of every other sub-array in the antenna. The null-points in the beam pattern for any one sub-array would be at the same azimuth positions in the azimuthal beam patterns for all sub-arrays. The result one would expect is an overall beam pattern for the antenna which, being the weighted sum of the beam patterns of each of the contributing antenna sub-arrays (the choice of weights determines the formed beam properties), would have null points located at the same azimuth positions as the null points of the sub-array beam patterns. This result would severely hinder the ability of the antenna to be used to adaptively form a beam, by a process of adaptive beam forming, in any azimuthal direction corresponding to that of a null point. Furthermore, it is desirable to be able to adaptively form nulls in a beam pattern at a desired angular position where beam lobes, or portions of them, may otherwise reside. Doing so can assist in reducing the antenna's sensitivity to sources of noise originating from such an angular position, such as natural external noise sources. Of course, the same discussion applies equally in the elevation direction when the antenna is turned by 90 degrees such that the sub-arrays of radiating elements extend in a vertical array.

To the great surprise of the inventors, it has been found that the antenna of the invention is able to be used adaptively to form antenna beams in directions where one would have expected a null to exist, for the reasons given above.

FIG. 4 schematically shows the angular distribution, in azimuth, of the radar beam sensitivity pattern of an antenna of the present invention (FIGS. 2 and 3) comprising two substantially identical sub-arrays of antennas as described above. A first beam pattern corresponding to the first sub-array (3A) displays a main beam (30A) and a number of side-lobes (30B) each spaced from the main beam and/or from a neighbouring side lobe (30B) by a beam “null” point where the beam patter falls close to zero (effectively so for practical purposes). A second beam pattern corresponds to the second sub-array (3B) and comprises a main beam (40A) and a number of side-lobes (40B) each spaced from the main beam and/or from a neighbouring side lobe (40B) by a beam “null” point where the beam patter falls to, or close to, zero. Even though the second antenna sub-array designed and manufactured to be substantially identical to the first antenna sub-array, it has been found that the nulls in the second beam pattern do not occur at the same azimuth position as the nulls in the first beam pattern. This is an unexpected result.

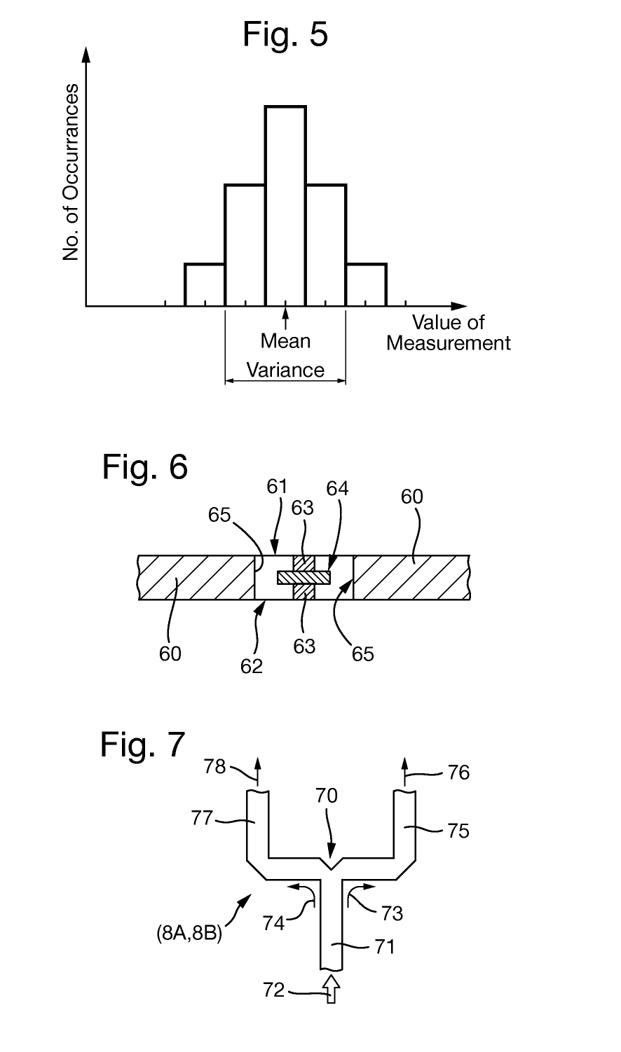

It has been found that variations of certain key structural and operational parameters of each sub-array in the antenna are responsible for variations in the beam pattern levels at every direction (e.g. azimuth), and also the location of the nulls, in the beam pattern of a given antenna sub-array. FIG. 5 graphically illustrates this. When a measured value of a given parameter of one sub-array is repeated over all sub-arrays in the antenna (two sub-arrays in the present embodiment, but many more such sub-arrays may be added to the stack), a degree of inherent random variation occurs in the value of that measured parameter. This occurs due to random influences in the construction and manufacture of the antenna arrays which varies randomly from one array to the next. The statistical distribution of the values of the same measured parameter, measured identically as between different sub-arrays in the antenna, is shown schematically in FIG. 5, and settles about a mean value, with a variation about that mean value which is quantifiable by the variance in the measurements.

It has been found that beam pattern diversity such as shown in FIG. 4, may be achieved by ensuring that the value of the variance in the measured values of certain key parameters is greater than a lower threshold value, but less than an upper threshold value. The upper threshold value constrains random variations in design parameters such that the beam pattern of the antenna is acceptable—principally, that the main beam is sufficiently well-defined, and/or has the required gain and the side lobes are of acceptably low value.

However, the lower threshold level is a value required to achieve beam pattern diversity such that the required flexibility of adaptive beam-forming (e.g. expressed in terms of a Cancellation Ratio) is achieved.

The design parameters whose variance values are most influential in providing pattern diversity in this way are as follows.

(a) a variance of the power splitting ratio of corresponding (i.e. co-registered) signal power dividers of the two or more antenna sub-arrays.

(b) a variance of the input RF signal reflectivity of corresponding (i.e. co-registered) signal power dividers of the two or more antenna sub-arrays.

(c) a variance in the phase balance of the corresponding (i.e. co-registered) signal power dividers of the two or more antenna sub-arrays. (d) a variance in the amplitude balance of the corresponding (i.e. co-registered) signal power dividers of the two or more antenna sub-arrays.

(e) a variance of the waveguide path lengths of corresponding (i.e. co-registered) waveguide paths of the two or more antenna sub-arrays, measured from the signal input/output port of the sub-array to a given radiating element.

The existence and degree of such variances in any one of, or in any combination in some or all of these design parameters may therefore be controlled to be the means for providing the desired cancellation ratio and pattern diversity.

The stripline waveguides comprise suspended, channelized air stripline waveguides such as is schematically shown in FIG. 6. The stripline waveguide (64) conductor is located within an air-filled channel formed between two opposing walls (65) of a dielectric spacer material (60) which are separated by a distance defining the width of the air channel, and between two opposing surfaces of an upper conductive groundplane plate (61) and a lower, parallel conductive groundplane plate (62) separated by the width of the dielectric spacer to define the height of the air channel. A first of two remote columns (63) of the dielectric spacer material is located between the upper groundplane plate and the opposing upper surface of the stripline waveguide. Simultaneously, a second of the two remote columns (63) of the dielectric spacer material is located between the lower groundplane plate and the opposing lower surface of the stripline waveguide. Thereby, the two remote columns sandwich the stripline waveguide between them. Multiple such sandwiching pairs of dielectric spacer columns are arranged along each stripline length extending from input/output port to radiating antenna element.

The separate antenna elements are connected to the RF signal input/output port of a given sub-array via respective RF signal power dividers formed from stripline waveguides as shown in FIG. 7, and these are also as supported and arranged as shown in FIG. 6. In the embodiment described here, a mean value (e.g. FIG. 5) of the signal power splitting ratio of the corresponding RF signal power dividers is about 3 dB, thereby providing a substantially balanced split (equal division/split, or combination of equal input RF powers when working in reverse for a received radar signal). However, in other embodiments the power splitting ratio may be greater than 3 dB—e.g. in the range between 3 dB and about 9 dB. In this way, one, some or all of the power dividers of a given sub-array may be arranged to provide an unequal split of RF power (or combination of unequal RF powers when working in reverse for a received radar signal). As an example, if using simple impedance ratio splits, one may employ splits within a range of about 2 dB to about 5 dB (referred to the input). Other forms of power splits are possible, such as via directional couplers, that may employ a ratio above about 6 dB. Also, multiple-ration split geometries may be employed which provide a single input and multiple (e.g. tailored) outputs and can deliver a wide range of splitting ratios.

The embodiments described above are presented for illustrative purposes and it is to be understood that variations, modifications and equivalents thereto such as would be readily apparent to the skilled person are encompassed within the scope of the invention.

1. An antenna comprising two or more substantially identical antenna sub-arrays each comprising a plurality of separate antenna radiating elements connected to a common radio frequency (RF) signal input/output port, wherein:
(a) the separate antenna elements are connected to the RF signal input/output port via respective RF signal power dividers and a variance in values of the power splitting ratio, and/or of the input RF signal reflectivity, and/or of the phase balance of corresponding signal power dividers of the two or more antenna sub-arrays is sufficient to provide a cancellation ratio exceeding 40 dB;
and/or wherein:
(b) the separate antenna elements are connected to the RF signal input/output port via respective transmission paths and a variance in values of the transmission path lengths of corresponding signal transmission paths of the two or more antenna sub-arrays is sufficient to provide a cancellation ratio exceeding 40 dB.

2. An antenna according to claim 1 in which said separate antenna elements are connected to the RF signal input/output port via respective stripline transmission lines.

3. An antenna according to claim 2 in which said stripline transmission lines comprise a suspended stripline transmission lines.

4. An antenna according to claim 2 in which said stripline transmission lines comprise a channelized air stripline transmission lines.

5. An antenna according to claim 1 in which said separate antenna elements are connected to the RF signal input/output port via respective RF signal power dividers formed from stripline transmission lines.

6. An antenna according to claim 1 in which a mean value of the signal power splitting ratio of said corresponding RF signal power dividers is greater than 3 dB.

7. An antenna according to claim 1 in which each said sub-array is substantially planar whereby said plurality of separate antenna radiating elements are connected to said radio frequency (RF) signal input/output port substantially in a common plane and wherein said two or more sub-arrays are arranged substantially in parallel.

8. An antenna according to claim 7 in which at least two of said two or more sub-arrays are arranged mutually in register with said respective radiating elements of a first sub-array substantially in register with said radiating elements of a second sub-array.

9. A method of manufacturing an antenna comprising two or more substantially identical antenna sub-arrays each having a plurality of separate antenna radiating elements connected to a common radio frequency (RF) signal input/output port, wherein:
(a) the method includes providing the separate antenna elements connected to the RF signal input/output port via respective RF signal power dividers formed such that a variance in values of the power splitting ratio, and/or of the input RF signal reflectivity, and/or of the phase balance of corresponding signal power dividers of the two or more antenna sub-arrays is sufficient to provide a cancellation ratio 40 dB;
and/or wherein:
(b) the method includes providing the separate antenna elements connected to the RF signal input/output port via respective transmission paths formed such that a variance in values of the transmission path lengths of corresponding signal transmission paths of the two or more antenna sub-arrays is sufficient to provide a cancellation ratio 40 dB.

10. A method according to claim 9 including providing said sub-arrays with said separate antenna elements connected to the RF signal input/output port via respective stripline transmission lines.

11. A method according to claim 10 including providing said stripline transmission lines in the form of suspended stripline transmission lines.

12. A method according to claim 10 including providing said stripline transmission lines in the form of channelized air stripline transmission lines.

13. A method according to claim 9 including providing said sub-arrays with said separate antenna elements connected to the RF signal input/output port via respective RF signal power dividers formed from stripline transmission lines.

14. A method according to claim 9 including providing said corresponding signal power dividers with a mean value of the signal power splitting ratio which is greater than 3 dB.

15. A method according to claim 9 including providing each said sub-array as substantially planar whereby said plurality of separate antenna radiating elements are connected to said radio frequency (RF) signal input/output port substantially in a common plane and the method includes arranging said two or more sub-arrays substantially in parallel.

16. A method according to claim 15 including arranging at least two of said two or more sub-arrays mutually in register with said respective radiating elements of a first sub-array substantially in register with said radiating elements of a second sub-array.
